(19) United States
(12) Patent Application Publication
(10) Pub. No.: US 2022/0314827 A1
(43) Pub. Date: Oct. 6, 2022

(54) Vehicle unit comprising a charging connection, and charging device for charging a battery of an electric vehicle

(71) Applicant: Webasto SE, Stockdorf (DE)

(72) Inventor: Thomas Podolski, Stockdorf (DE)

(21) Appl. No.: 17/634,458

(22) PCT Filed: Aug. 17, 2020
(86) PCT No.: PCT/EP2020/072973

§ 371 Date: Feb. 10, 2022

(30) Foreign Application Priority Data
Aug. 16, 2019 (DE) 10 2019 122 051.3

(51) Int. Cl. B60L 53/35; B60L 53/16; H01R 13/453; H01R 13/62

(52) U.S. Cl. CPC B60L 53/35; B60L 53/16; H01R 13/4534; H01R 13/62; H01R 2201/26

(57) ABSTRACT

A vehicle unit comprising a charging connection for charging a battery of an electric vehicle, where the vehicle unit is provided in the floorpan of the electric vehicle, and the charging connection is designed to be connected to a contacting element on a plane running parallel to the floorpan.

### TECHNICAL FIELD

The present invention relates to a charging device for charging a battery of an electric vehicle, in particular for charging a traction battery of a motor vehicle driven by an electric motor, for example a vehicle driven exclusively by an electric motor or a plug-in hybrid vehicle, in particular for automatically charging this traction battery.

### BACKGROUND ART

Electric-drive motor vehicles are becoming increasingly popular because they are considered to be an environmentally friendly alternative to vehicles that have an internal combustion engine, while at the same time helping to reduce the CO₂ emissions of the respective vehicle fleets.

Electric-drive motor vehicles are known, for example, as vehicles that have wholly electric drive, in which the energy required for driving is stored exclusively in a traction battery. Also known are electric-drive motor vehicles that have both an internal combustion engine and an electric motor for propulsion. These motor vehicles are also referred to as hybrid vehicles. In the case of hybrid vehicles, the energy required to drive the electric motor is also stored in a traction battery. If this traction battery can be charged externally, for example by connecting it to a charging device connected to the general electricity supply grid, these motor vehicles are referred to as plug-in hybrid vehicles.

For the purpose of charging traction batteries in the case of electric-drive motor vehicles, it is known to effect contacting of the motor vehicle to a charging means, for example a wallbox, in that a user guides a charging cable from the wallbox to the motor vehicle, where it is plugged into a corresponding socket. A secure connection between the wallbox and the motor vehicle can thus be established in such a manner that charging is easily achieved.

On the other hand, the provision of such a wallbox in combination with a cable is not very space-saving, since the charging cable extends from the wallbox, which may be provided in a wall region, for example in a garage, to the motor vehicle, and can thus block the passage or at least constitute a tripping hazard. Furthermore, the manual process of plugging the charging cable into the motor vehicle is perceived as inconvenient by some users. This can lead to forgetting to connect the vehicle for charging, or even forgetting, before driving off, that the vehicle is still connected to the wallbox by the charging cable. Although immobilizers usually prevent mechanical damage, the user still has to get out of the vehicle and disconnect the charging cable from the vehicle.

Forgetting to connect the vehicle to the wallbox can mean that charging of the traction battery of the motor vehicle does not take place, and the traction battery may not be sufficiently charged the next time the vehicle is started.

Accordingly, there are efforts to automate the contacting for charging the vehicle starting from a charging device. There are various concepts for this, there having been proposed, for example, wall-mounted automatic contacting devices that automatically/mechanically plug in a charging cable that was previously inserted manually by a user into the socket on the motor vehicle. This can be achieved, for example, via a scissor arm.

Also known are contacting devices that are arranged on the floor of a parking space. In the case of these contacting devices, a motor vehicle drives over the respective charging device and then the motor vehicle is automatically contacted from below via a corresponding lifting device. Various lifting devices are known for this purpose, by means of which a plug can be inserted from below into a socket arranged in the floorpan of the motor vehicle.

However, the contacts of the vehicle unit located in the floorpan of the motor vehicle, as well as the contacts of a floor unit, are exposed to mechanical damage caused by stone chips, fouling and splash water.

DE10 2018 205 594 A1 discloses an automatic charging device for an electric vehicle, in which a contacting unit arranged in the floorpan of the vehicle can be contacted by means of a movable arm. The contacts of the contacting unit in this case are protected by a linearly displaceable cover. The contacting is effected in a plane perpendicular to the floorpan of the electric vehicle.

DE10 2016 222 853 A1 discloses a coupling means arranged on the floorpan of the electric vehicle, having a plug that can be moved from a rest position to a plug-in position and back.

### SUMMARY OF THE INVENTION

Based on the known prior art, it is an object of the present invention to provide an improved device for charging an electric vehicle, as well as a corresponding method.

The object is achieved by a vehicle unit having the features of claim 1. Advantageous further developments are given by the dependent claims, the description and the figures.

There is accordingly proposed a vehicle unit comprising a charging connector for charging a battery of an electric vehicle, wherein the vehicle unit is arranged in the floorpan of the electric vehicle. According to the invention, the charging connector is designed to be connected to a contacting element in a plane parallel to the floorpan of the electric vehicle.

In other words, a movement between the contacting element and the charging connector is effected in a plane parallel to the floorpan of the electric vehicle in such a manner that contacting is effected between the contacting element and the charging connector.

This connecting of the charging connector in a plane parallel to the floorpan of the electric vehicle enables the respective connectors and contacts for contacting between the contacting element and the charging connector also to be provided in an alignment parallel to the floorpan of the electric vehicle. It is thereby possible to reduce the susceptibility to fouling, wear and damage due to driving influences, and thus to make the vehicle unit more robust.

In the case of an electric vehicle parked on a flat floor, the plane parallel to the floorpan of the electric vehicle is also at the same time horizontal.

The plane formed by the floorpan of the electric vehicle may be accommodated by parts of a housing of the vehicle unit. For example, the bottom of the vehicle unit may extend substantially in the plane formed by the floorpan of the electric vehicle.

The electric vehicle is preferably a motor vehicle that has wholly electric drive or a plug-in hybrid vehicle, in which the energy required for electric driving is stored in a battery of the electric vehicle, also known as a traction battery.

In order to achieve particularly simple contacting between the charging connector and the contacting element in the plane defined by the floorpan of the electric vehicle, the vehicle unit may have a positioning element for positioning and/or guiding the contacting element to the charging connector. The positioning element can accordingly be brought into contact with the contacting element and then, by a corresponding movement of the positioning element, effect or undo contacting.

In a mechanically particularly preferred embodiment variant, the positioning element may comprise a pin, or be realized by a pin, that can be brought into contact with the contacting element. Other mechanical designs for the positioning element, that be brought into preferably positive engagement with the contacting element, are conceivable.

The positioning element in this case may comprise a drive by means of which the positioning element is brought into engaging contact with the contacting element in order then to bring the contacting element to connect to the charging connector.

Preferably, the vehicle unit has a cover for covering the charging connector, wherein the cover, when in the closed state, preferably lies flat with the floorpan. This provides even better protection for the charging connector, which in turn enables the construction of a robust and durable vehicle unit.

The cover in this case may be movable, particularly preferably by means of a drive, between a closed position and an open position, and the drive can preferably also actuate the positioning element.

In a preferred embodiment, the vehicle unit may comprise a housing defining a recess, preferably comprising an elongated recess, and the charging connector may be arranged at a first end of the recess such that the contacts of the charging connector are parallel to the floorpan. In other words, the charging connector may be arranged in a recess in the vehicle unit, in order thereby to provide a particularly protected configuration of the vehicle unit.

In a preferred design, the positioning element, for the purpose of positioning and/or guiding the contacting element, is arranged at the second end of the recess, opposite the charging connector. This makes it possible to advance the contacting element with precision to the charging connector.

In an alternative design, the positioning element is arranged in a fixed position in the vehicle unit, preferably in the recess, and the charging connector may be moved relative to the housing of the vehicle unit by means of a drive, such that the charging connector can be moved onto a contacting element. The movement of the charging connector in this case is effected in the plane parallel to the floorpan of the electric vehicle.

In a further design, both the positioning element and the charging connector may be moved such that the charging connector can be moved with a contacting element in a plane formed by the floorpan of the motor vehicle, and can thereby be contacted.

In a mechanically preferred design, the positioning element is connected via a toggle lever arrangement to a drive for opening and/or closing a cover of the recess. The toggle lever arrangement thus enables the positioning element to describe a preferred trajectory by means of which it can be used to move and lock the contacting element.

The positioning element is movable in the direction of the charging connector in order to effect coupling of the contacting element to the charging connector. In other words, the positioning element can move the contacting element into the charging connector.

In a preferred design, a drive for the cover has an over-center kinematic system by which the cover, when in the closed state, can be closed in a tight manner. This enables the cover to be held in the closed state with a high closing force by application of a small holding force by the drive.

Particularly preferably, a drive for the cover is coupled to a drive of the positioning element, preferably in the form of a pin, in such a manner that, when the cover is opened, the positioning element is rotated in the direction of the floor and, when the cover is closed, the positioning element is rotated back into the recess, wherein the positioning element is preferably rotated through an angle that is greater than 30°, preferably more than 45°. It can thus be achieved that the positioning element protrudes from the recess and can thus be used for guiding and positioning the contacting element. At the same time, however, a compact construction dimension can be achieved and the cover can be realized so as to be flat with the floorpan.

The abovementioned object is also achieved by a charging device having the features of claim 12. Advantageous further embodiments are given by the dependent claims, the description and the figures.

There is accordingly proposed a charging device for charging a battery of an electric vehicle, which comprises a vehicle unit as described above and a floor unit arranged on the floor and having a contacting element attached to a contacting arm. The contacting element in this case can be connected to the charging connector of the vehicle unit for the purpose of establishing an electrical connection. According to the invention, the charging connector and the contacting element are designed to be connected to each other in a plane parallel to the floorpan of the vehicle.

In this way, the advantages described above can be achieved.

Preferably, the contacting element is arranged on the contacting arm in such a manner that it is always aligned parallel to the floorpan, irrespective of the position of the contacting arm, preferably by means of a parallelogram guide. It is thereby possible to achieve reliable contacting of the charging connector in a plane parallel to the floorpan of the electric vehicle.

Preferably, the contacting element has a receiving unit for receiving a positioning element for positioning the contacting element with respect to the vehicle unit.

Preferably, the receiving unit and the vehicle unit have sensors for locating the receiving unit with respect to the vehicle unit and in particular with respect to the recess. It is thereby possible to achieve automatic positioning of the contacting element with respect to the charging connector.

Also proposed, according to claim 16, is a method for automatically charging an electric vehicle, comprising the following steps: providing a vehicle unit mounted in the floorpan of the electric vehicle and comprising a charging connector, wherein the charging connector is arranged parallel to the floorpan of the electric vehicle, providing a floor unit having a contacting arm at the free end of which a contacting element is arranged in a plane parallel to the floorpan of the vehicle, approaching the contacting arm to the vehicle unit, and displacing the contacting element in the direction of the charging connector, parallel to the floorpan of the electric vehicle.

In an advantageous further development, after the contacting element has been approached to the vehicle unit, a receiving unit of the contacting element is brought into engagement with a positioning unit of the vehicle unit to form a pivot axis, and an alignment of the contacting element with respect to the vehicle unit is effected by a pivoting of the contacting element about the pivot axis, caused by a movement of the contacting arm.

Preferably, a positioning element is provided that is designed for positioning and aligning the contacting element arranged on the contacting arm.

The positioning element allows the contacting arm and the contacting element to be of a particularly efficient design, and it is possible, for example, to dispense with a separate drive for the alignment of the contacting element. Owing to the fact that the contacting element is brought into engagement with the positioning element, it is possible, for example, to achieve a rotational orientation of the contacting element by means of a pivot drive of the contacting arm, the contacting element being arranged on the contacting arm via a freely rotatable axis of rotation, and engagement between the positioning element and the contacting element being effected in a position radially spaced from the axis of rotation.

### BRIEF DESCRIPTION OF THE FIGURES

Preferred further embodiments of the invention are explained in more detail by the following description of the figures, wherein:

FIG. 1 shows a schematic perspective view from below of a vehicle unit with a cover in a closed position,

FIG. 2 shows a schematic perspective view of the vehicle unit from FIG. 1, in which the cover is arranged in an open position,

FIG. 3 shows a schematic quasi-transparent representation of the vehicle unit from FIGS. 1 and 2, with the vehicle unit having been rotated 90° counter-clockwise,

FIG. 4 shows a schematic transparent side view of the vehicle unit from the preceding figures,

FIG. 5 shows a schematic transparent side view of the vehicle unit with the cover in a closed position,

FIG. 6 shows a schematic perspective view of the charging device with the transparently represented vehicle unit in a closed state and with an approaching contact arm,

FIG. 7 shows the charging device from FIG. 6 with the vehicle unit, with the cover fully open and the contact arm approaching,

FIG. 8 shows the charging device from FIG. 7, a guide pin of the vehicle unit being in engagement with a contacting element of the contacting arm,

FIG. 9 shows the charging device from FIG. 8, with the contacting element being inserted into a recess of the vehicle unit, and

FIG. 10 shows the charging device from FIG. 9, the contacting element being fully contacted to the charging connector.

### DETAILED DESCRIPTION OF PREFERRED EXEMPLARY EMBODIMENTS

In the following, preferred exemplary embodiments are described on the basis of the figures. In the different figures, elements that are the same or similar or that have the same effect are denoted by identical reference signs, and repeated description of these elements is partially omitted in order to avoid redundancies.

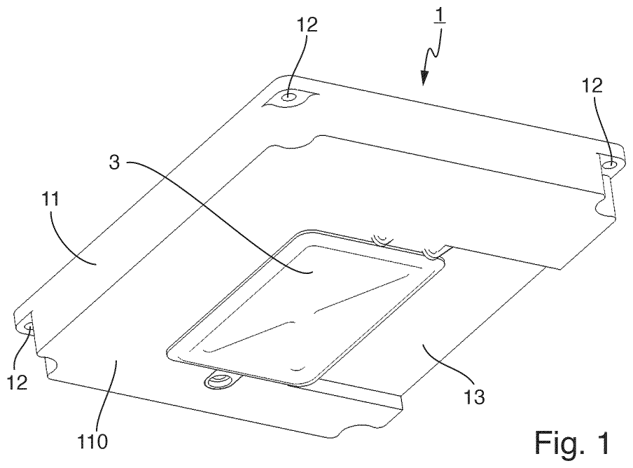

Shown schematically in FIG. 1 is a vehicle unit 1 of a charging device. The vehicle unit 1 is designed to be arranged in an electric vehicle.

The vehicle unit 1 can be used to achieve contacting of a traction battery, arranged in the electric vehicle, to a current source providing a charging current, by means of a contacting arm, not shown in the Figure, of a ground unit that is likewise not shown.

The power source providing the charging current may be provided in the form of a wallbox. The charging control system may also be provided in the wallbox.

The electric vehicle may be an electric vehicle powered solely by an electric motor, or a plug-in hybrid electric vehicle.

The charging device is used to effect automatic contacting to an electric vehicle, and then to start a charging operation in order to charge a traction battery in the electric vehicle. The charging device in this case is intended to enable the entire contacting operation and the charging operation to proceed substantially automatically, such that the driver, or user, of the electric vehicle does not have to intervene.

The driver only has to position, or park, the vehicle over a floor unit arranged in/on the floor of the parking space for the vehicle, and the remaining steps of the contacting operation and charging operation are then effected without further interaction with the driver, or user. A contacting operation is then effected between a vehicle unit, arranged in the floorpan of the vehicle, and the floor unit.

In other words, automatic communication can be effected between the electric vehicle to be charged and the charging device and, for example if the charging level of the electric vehicle falls below a predefined level, a charging operation can be started automatically. However, it is also possible for the driver to actively initiate the charging operation, in which case at least no further manual interaction between the driver and the charging device is necessary.

The charging device will then establish a physical contact with the motor vehicle via a contacting mechanism described below, in order thereby to provide a charging current for charging the traction battery of the motor vehicle. In particular, a contacting element of the ground unit is connected to a charging connector of the vehicle unit and in this way a contact is established.

Accordingly, the charging device can allow particularly convenient operation of a motor vehicle provided with an electric motor and an associated traction battery, in which the driver does not have to take any further steps after parking the motor vehicle over the floor unit and possibly initiating the charging operation, as the charging device performs this automatically and autonomously.

In particular, it is not necessary for the user of the motor vehicle, in order to contact the traction battery to a charging device, to manually lead a charging cable with a plug from a wallbox to the motor vehicle and then to perform a corresponding plug-in, but rather this manual process can be omitted.

Similarly, the proposed charging device can be used to avoid a situation in which a user wants to drive off while the vehicle is still connected and then has to get out of the vehicle again to undo the connection. Rather, by means of the proposed charging device, it is also possible to achieve an automatic, autonomous disconnection that is effected, for example, when the actual charging operation has been completed, i.e. the traction battery is completely filled again, or alternatively triggered, for example, by opening of the motor vehicle or entry into the interior of the motor vehicle, or starting of the motor vehicle. In other words, a user does not have to take any active steps even to disconnect the existing contacting of the charging device. It may also be provided, however, that the user specifies an active disconnection by a corresponding disconnection command.

The vehicle unit 1 arranged in the electric vehicle has a housing 11 that can be accommodated in a corresponding accommodation in the electric vehicle. The vehicle unit 1 in this case may be mounted on or in the floorpan of the electric vehicle by means of screws. For this purpose, for example, screw holes 12 are provided at four corners of the housing 11.

The vehicle unit 1 may be integrated with a flat surface in the floorpan of the electric vehicle. To realize the flat-surface integration, the housing 11 of the vehicle unit 1 is inserted into the electric vehicle to such an extent that the downward-facing bottom 110 of the housing 11 is substantially flush with the floorpan of the electric vehicle.

It is also possible for the vehicle unit 1 to be mounted on the side or on the roof of the electric vehicle, but the further exemplary embodiments are limited to mounting the vehicle unit 1 on or in the floorpan of the electric vehicle.

A vehicle unit 1 mounted in the region of the floorpan is designed for automatically charging a traction battery, with the electrical connection between the vehicle unit 1 and a floor unit being established automatically.

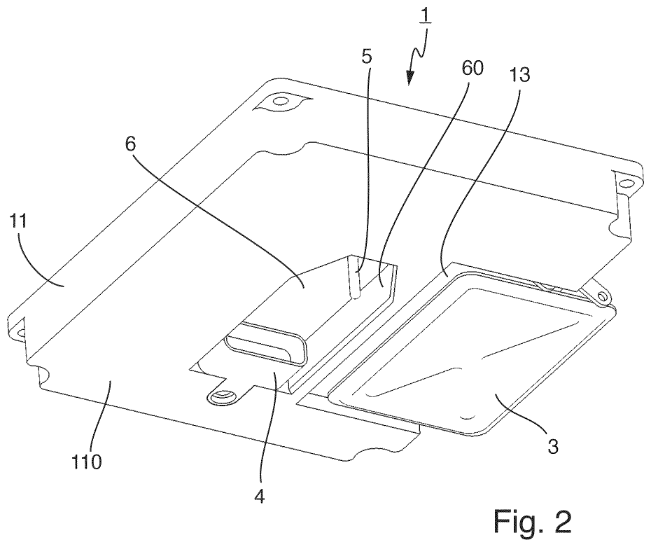

The vehicle unit 1 is shown in FIG. 1 in a view from below, in which a cover 3, for covering a recess 6 shown in FIG. 2, which accommodates a charging connector 4, can be seen in a closed position.

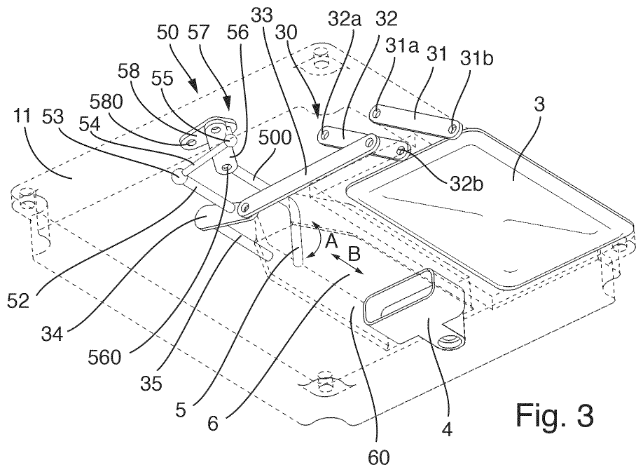

The cover 3 is designed to move from an open position to a closed position by means of a four-bar linkage, as described in detail in relation to FIG. 3, inter alia.

Also conceivable is an embodiment of the cover 3 having a drive that moves the cover translationally from a closed position to an open position.

However, for the harsh conditions under a vehicle, mounting of the cover 3 via a four-bar linkage is preferred in comparison to a purely translational mounting because the cover 3 is then less susceptible to fouling and is easier to clean, e.g. as part of the regular servicing by a specialist workshop.

Preferably, the cover 3 closes the vehicle unit 1 with a flat surface.

Preferably, the housing 11 of the vehicle unit 1 has a cavity 13 into which the cover 3 can move when it is opened in order for the underside of the housing 11 to form a flat surface together with the cover 3 when it has been moved into the open position. In the open state, a flat-surface design is particularly preferred in order to facilitate the insertion of a contacting element and in particular to prevent the contacting element from catching on the different structures of the floorpan.

Represented schematically in FIG. 2 is the vehicle unit 1 from FIG. 1 with the cover 3 in an open position. For this, the cover 3 has been moved into the recess 13 provided for this purpose in the housing 11 of the vehicle unit 1.

As a result of the cover 3 having been moved to the side, a recess 6 is now exposed in which a charging connector 4 and a positioning element are arranged. In the exemplary embodiments, the positioning element is shown in the form of a pin 5. However, in other exemplary embodiments, the positioning element may also be provided in other mechanical designs—preferably those that enable positive engagement between the contacting element and the positioning element.

The charging connector 4 comprises the contacts by means of which contacting for the purpose of electrically charging the battery of the electric vehicle can be achieved. The contacts of the charging connector 4 are designed to be connected to a contacting element that is realized, for example, as a plug. The charging connector 4 is then correspondingly realized in the form of a socket for receiving the contacting element realized as a plug.

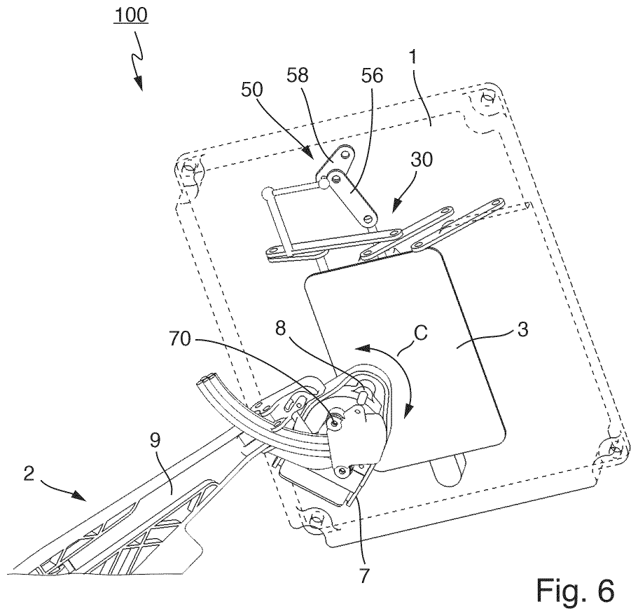

The contacting element and its advancement by means of a contacting arm is described below with reference to FIGS. 6 to 10.

The charging connector 4 and its contacts are designed in such a manner that insertion (and release after the end of the charging operation) of the contacting element can be performed in a direction that is in a plane parallel to the floorpan of the vehicle. In other words, the charging connector 4 and its contacts are in an orientation parallel to the bottom of the housing 11 of the vehicle unit 1, such that contacting can be achieved by a movement in a direction that is in the plane of the floorpan.

The pin 5 is used to guide and/or move and/or position the contacting element, as will also be explained below with reference to FIG. 3 and FIGS. 6 to 10.

The charging connector 4 and the pin 5 are protected in the recess 6, such that the risk of fouling or damage due to environmental and driving influences can be reduced. This protection would already be provided by the recess 6 alone, especially if the charging connector 4 is located in the “wind shadow” of the walls 60 of the recess defining the recess 6, such that dirt, water and stone chips do not hit the charging connector 4 directly during driving, but rather, as with were, sweep over it.

If the recess 6 is then completely closed by the cover 3 and thus the charging connector 4 and the pin are protected, fouling during driving can be completely prevented and thus the durability and function of the charging connector 4 can be maintained over a long period of time.

Represented in FIG. 3, and corresponding to FIG. 2, is vehicle unit 1 with the cover 3 in an open position, viewed from below. In order to show the components provided in the vehicle unit more precisely from this perspective and from the other perspectives, in this figure and in the following figures the housing 11 of the vehicle unit 1 is shown in a transparent representation.

Accordingly, FIG. 3 shows a drive 30 for the cover 3, and a drive 50 for the pin 5.

As can be seen, the cover 3 is articulated to the housing 11 via a parallelogram guide that has two guide legs 31, 32. The cover 3 is thus articulated to the housing 11, as it were, via a four-bar linkage and can be moved by means of the drive 30 from the closed position, as shown in FIG. 1, to the open position, as shown in FIG. 2. From the closed position, the cover 1 is therefore first lifted by this linkage and then pivoted into the open position, such that it is received in the recess 13. Of course, a pivoting of the cover 3 from the open position to the closed position is also achieved by means of the drive 30. Thus, the cover 3 always rotates parallel to the floorpan of the vehicle from an open position to a closed position and vice versa.

The guide legs 31, 32 in this case are pivotably mounted on the housing 11 via pivot joints 31a, 32a, and pivotably mounted on the cover 3 via pivot joints 31b, 32b.

The drive 30 has a drive axle 35, driven by a motor or a servo and having a radial lever 34 and, articulated to the radial lever 34, a coupling element 33 that in turn is articulated to one of the guide legs 32 of the parallelogram guide of the cover 3. Via a rotation of the drive axle 35, a corresponding movement can thus be applied to the guide leg 32, such that the pivoting movement for opening and closing the cover 3 can be applied by means of the motor or servo.

The drive axle 35 in this case is parallel to the pivot axes of the parallelogram guide for the cover 3 that is realized by means of the pivot joints 31a, 31b, 32a, 32b.

In other words, the drive 30 converts the rotation of the drive axle 35 into an opening/closing movement of the cover 3.

Furthermore, the cover 3 can be easily and reliably held in the closed position by means of an over-center kinematics system of the drive 30, as will be described for example in relation to FIG. 5.

Preferably, the drive 30, and in particular its motor or servo for the cover 3, also actuates the drive 50 for the pin 5. However, a separate drive for the pin 5 is also conceivable.

In the present exemplary embodiment, the drive 50 for the pin 5 is correspondingly coupled to the radial lever 34, such that the motor or servo actuating the radial lever 34 also drives the drive 50.

The drive 50 comprises an eccentric axle 52, which is arranged on the radial lever 34 and which, in the exemplary embodiment shown, extends parallel to the drive axle 35, and a pull element 54, which is arranged on the latter via a first ball joint 53 and which is articulated to a first leg 56 of a toggle lever arrangement 57 via a second ball joint 55. A second leg 58 of the toggle lever arrangement 57 is also provided.

The eccentric axle 52 could also be dispensed with in the case of a radial lever 34 arranged at a different position or in a different plane, and the pull element 54 could then accordingly be arranged directly on the radial lever 34 in the eccentric position. Due to the eccentric arrangement of the pull element 54 on the radial lever 34, a pulling or pushing movement is accordingly exerted upon the pull element 54.

The pin 5 is arranged at the outer end 560 of the first leg 56 of the toggle lever arrangement 57, the pin 5 being both linearly displaceable and rotatably mounted in a bearing 500 that is not explicitly shown.

Instead of a simple bearing 500, a sliding guide may also be provided, by means of which the pin 5 can be moved in a precisely predefined trajectory—for example, it executes a pivoting movement in a first range of movement and a translational movement in another range of movement.

The outer end 580 of the second leg 58 of the toggle assembly 57 is articulated to the housing 11.

Due to the eccentric articulation of the pull element 54, the rotation of the radial lever 34 about the drive axle 35 accordingly results in a pulling movement (or, depending on the direction of rotation, also a pushing movement) being applied to the pull element 54, and thus to the first leg 56 of the toggle lever arrangement 57. There thus occurs, accordingly, a movement of the outer end 560 of the first leg 56, and thus a linear displacement of the pin 5 in the translational direction of movement B.

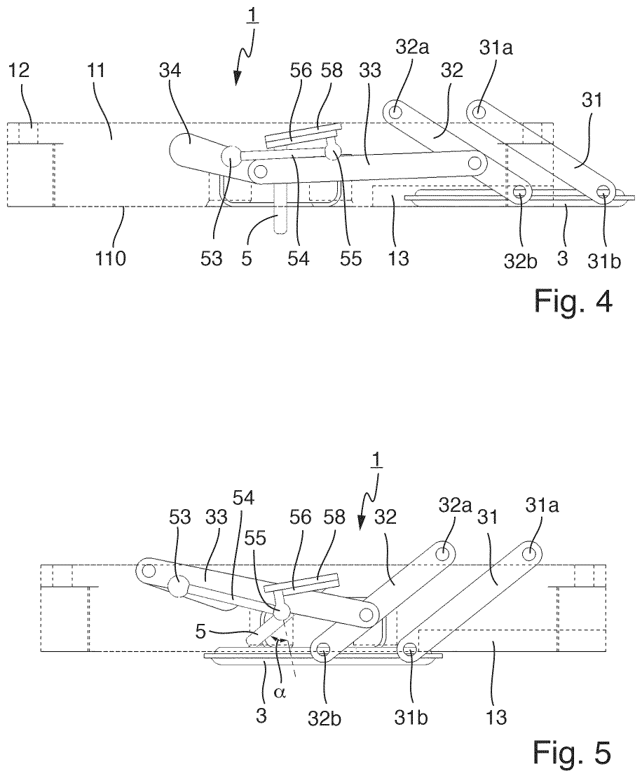

When the cover 3 is in a closed position, the pin 5 is rotated by an angle α in a rotational movement A from the position perpendicular to the floorpan, preferably by 45°, such that the cover 3 can be closed. This will be described again in more detail with reference to FIG. 5. However, the pin 5 can therefore extend downward beyond the opened recess 6, as can be seen for example in FIG. 4. This is important for positioning the contacting element and guiding it into the recess 6.

Accordingly, when the cover 3 is moved from a closed position to an open position, the pin 5 can rotate out of the recess 6 in the direction of rotation A, such that the pin 5 then protrudes downward from the recess 6, perpendicularly in relation to the floorpan, not later than when the cover 3 is fully open. During this rotational movement, the pin 5 is simultaneously subjected to the translational movement in direction B, the pin 5 substantially moving away from the charging connector 4 when the cover 5 is opened.

When the cover 3 is moved further from a fully open position to a partially closed position, the pin 5 simultaneously moves translationally in direction B toward the charging connector 4.

This coupling between the two actuators 30, 50 is explained further below from the point of view of the coupling procedure between the charging connector 4 and the contacting element 7.

In an alternative embodiment that is not shown here, the pin 5 may also be arranged in a fixed position in the housing 11, and instead the charging connector 4 may be realized in such a manner that it executes a translational movement in order to be connected to a contacting element. In this embodiment, which is not shown, the charging connector 4 in this case then moves, for example, toward a contacting element that has been inserted into the recess, in order thereby to achieve insertion and thus contacting of the charging connector 4 to the contacting element.

FIG. 4 shows a schematic side view of the vehicle unit 1 already presented in connection with FIGS. 1 to 3, with the cover 3 in an open position and with a transparent housing 11. The cover 3 is located in a cavity 13 in the housing 11 of the vehicle unit 1. The pin 5 protrudes from the recess 6, perpendicularly in relation to the floorpan of the vehicle, and is ready for connection to the contacting element 7.

FIG. 5 shows a schematic side view of the vehicle unit 1 with the cover 3 in a closed position. The cover 3 lies flat with the vehicle unit 1 over the recess 6 and thereby closes the access to the charging connector 4.

The pin 5 is rotated by an angle α from the vertical position toward the floorpan, such that it can be fully received in the recess 6 and the cover 3 can completely close off the recess 6.

FIGS. 6 to 10 show a connection method between a vehicle unit 1 and a floor unit 2. Shown schematically in FIG. 6 is a contacting arm 9 of a floor unit 2, there being a contacting element 7 connected to a free end of the contacting arm 9. The contacting element 7 is connected to the contacting arm 9 by means of a parallelogram guide so that the contacting element 7 always lies in a plane parallel to the floorpan of the vehicle irrespective of the movement of the contacting arm 9.

The contacting element 7 is arranged on the contacting arm 9 so as to be freely rotatable in the direction of rotation C about an axis of rotation 70 that is perpendicular to the plane of the floorpan. In one embodiment, the contacting element 7 is preloaded by a spring in an initial position with respect to the contacting arm 9, such that the contacting element 7 always moves into this initial position when it is otherwise unaffected. The contacting element 7 is shown in FIG. 6 in this initial position with respect to the contacting arm 9.

Instead of a contacting arm 9, another robot arm or another lifting mechanism could be used to advance the contacting element 7 to the vehicle unit 1.

The contacting element 7 in the present exemplary embodiment is rotatably arranged on the contacting arm 9 in a plane parallel to the floorpan of the vehicle. In FIG. 6, the contacting element 7 is approaching the vehicle unit 1 from below. The cover 3 of the vehicle unit 1 completely closes the recess 6, and thus also the charging connector 4.

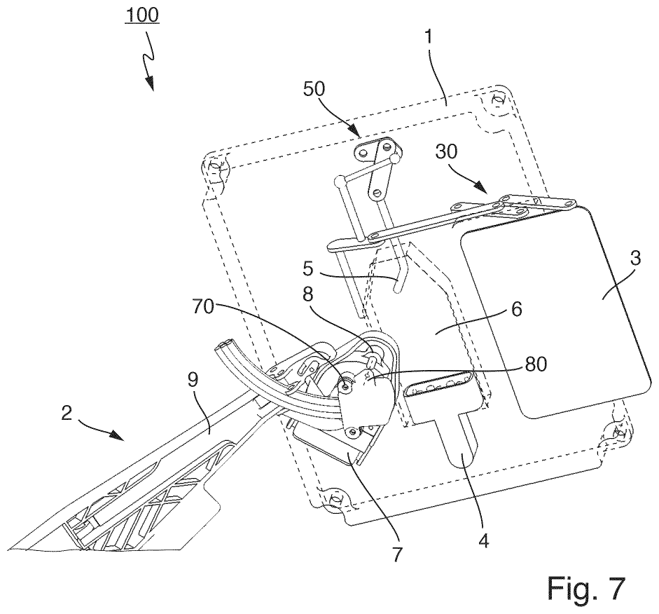

FIG. 7 shows the next connection step. The contacting element 7 has been raised so close to the vehicle unit 1 that a signal for opening the cover 3 is triggered, for example by means of sensors. The cover 3 is opened completely and the pin 5 simultaneously rotates out of the recess 6 toward the floor. Accordingly, the pin 5 then protrudes vertically downward from the recess 6 and is thus ready for connection with the contacting element 7.

A positioning sensor helps to guide a receiving unit 8 of the contacting element 4 to the pin 5 so that the positioning element, in the form of the pin 5, can be connected to the receiving unit 8. Different variants of proximity sensors may be used for this purpose, e.g. Hall sensors, optical sensors, ultrasonic sensors, etc.

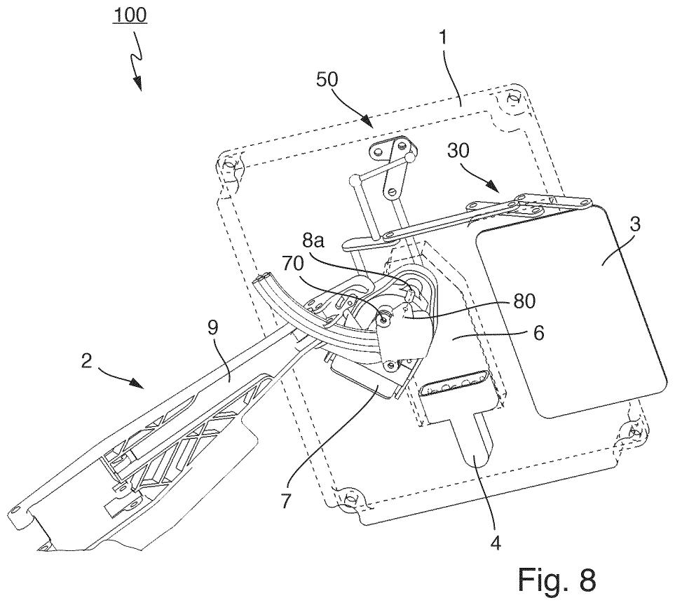

In FIG. 8, the contacting element 7 with the receiving unit 8 is placed on the pin 5. In the exemplary embodiment shown, the receiving unit 8 of the contacting element 7 in this case has a through-hole 8a that receives the pin 5 of the vehicle unit 1. In other words, the contacting element 7 is moved horizontally and vertically until the through-hole 8a can be pushed onto the pin 5.

After the pin 5 has been received in the through-hole 8a of the receiving unit 8, the contacting element 7 can be pivoted around the pin 5, in a plane parallel to the floorpan of the vehicle, about the thus formed pivot axis 80, until the contacting element 7 is aligned with the recess 6.

No separate drive is necessary for this pivoting of the contacting element 7 about the pivot axis 80 of the vehicle unit 1 formed by the pin 5 received in the through-hole 8a. Rather, pivoting about this pivot axis 80 can be achieved in that the contacting arm 9 is moved accordingly, and thus pivoting about this pivot axis 80 is achieved. At the same time, the contacting element 7 also rotates in the direction of rotation C about the axis of rotation 70, about which the contacting element 7 is pivotably attached to the contacting arm 9.

In other words, a rotational alignment of the contacting element 7, such that the contacting element 7 can then be inserted into the recess 6, can be achieved via the drives of the contacting arm 9 of the floor unit 2 and the drive 30 of the cover 3 of the vehicle unit 1, which are provided in any case.

This avoids the need for a separate motor, servo or drive for the rotational alignment of the contacting element 7, as well as for a separate motor, servo or drive for the positioning element.

The final alignment of the contacting element 7 relative to the recess 6 may be achieved, for example, by the provision of a marking or a grid on the pin 5. The contacting element 7 may also be controlled and aligned with respect to the recess 6 via the aforementioned sensor system in such a manner that the contacting element 7 is rotated into the intended position and in such a manner that it is possible for the contacting element 7 to be inserted into the charging connector 4.

As soon as the correct alignment of the contacting element 7 relative to the recess 6 is achieved, the contacting element 7 is lowered into the recess 6 so that contacts provided in the contacting element 7 can be brought into a respectively corresponding plane with the complementary contacts of the charging connector 4. In the process the pin 5 is pushed through the through-hole 8a in the receiving unit 8.

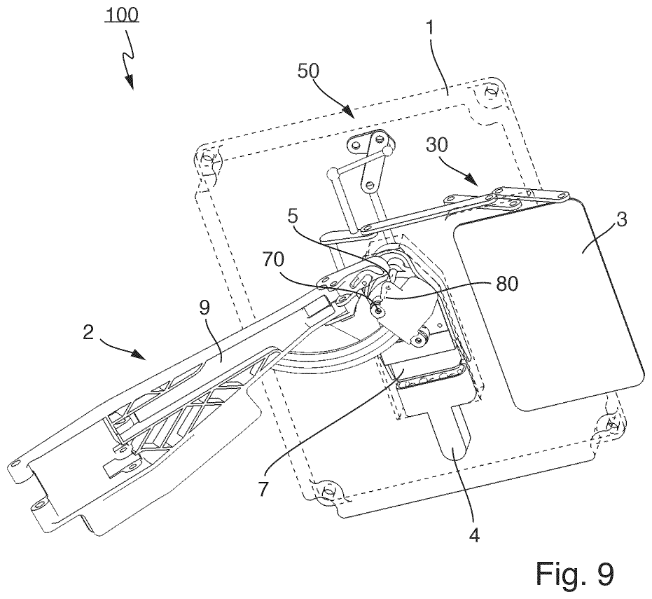

After the contacting element 4 has been rotated and raised into the recess 6, the contacts of the charging connector 4 are opposite complementary contacts of the contacting element 7, as can be seen in FIG. 9. The pin 5 that has penetrated the through-hole 8a in the receiving unit 8 can also be seen.

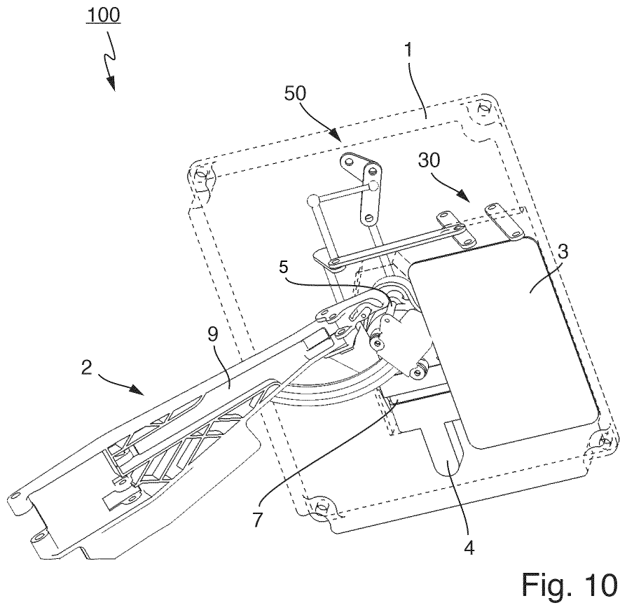

FIG. 10 shows the final connection step, the contacting element 7 being moved translationally in direction B of the charging connector 4 by means of the pin 5. Since the drive 50 for the pin 5 is connected to the drive 30 for the cover 3, the cover 3 is simultaneously moved from a fully open position to a partially closed position.

After the contacting element 7 has latched into the charging connector 4, the charging of the electric vehicle can begin.

When the charging operation is complete, the same steps are taken to separate the contacting element 7 from the vehicle unit 1 as were taken to connect the contacting element 7 to the vehicle unit 1, but this time in reverse order, although the exact alignment of the contacting element 7 can then also be omitted.

Where applicable, any of the individual features represented in the exemplary embodiments may be combined with each other and/or interchanged without departure from the scope of the invention.

### LIST OF REFERENCES

1 vehicle unit
11 housing
12 screw holes
13 cavity
110 bottom of the housing
2 floor unit
100 charging device
3 cover
30 drive for the cover
31 guide leg
32 guide leg
31a, 32a pivot joint
31b, 32b pivot joint
33 coupling element
34 radial lever
35 drive axle
4 charging connector
5 pin
50 drive for the pin
52 eccentric axle
53 first ball joint
54 pull element
55 second ball joint
56 first leg
57 toggle lever arrangement
58 second leg
500 bearing
560 outer end
580 outer end
6 recess
7 contacting element
70 axis of rotation of the contacting element on the contacting arm
8 receiving unit
8a through-hole in the receiving unit
80 pivot axis
9 contacting arm
α angle between the pin in home position and a vertical axis
A rotational movement
B translational movement
C direction of rotation

1: A vehicle unit comprising a charging connector for charging a battery of an electric vehicle, wherein the vehicle unit is arranged in a floorpan of the electric vehicle, wherein
the charging connector is designed to be connected to a contacting element in a plane parallel to the floorpan of the electric vehicle.

2: The vehicle unit as claimed in claim 1, wherein the vehicle unit has a positioning element in the form of a pin, for at least one of: positioning and guiding the contacting element to the charging connector.

3: The vehicle unit as claimed in claim 2, wherein the positioning element comprises at least one of: a drive by means of which the positioning element is brought into engaging contact with the contacting element in order to bring the contacting element to connect to the charging connector, and the drive by means of which the charging connector can be brought to connect to the contacting element.

4: The vehicle unit as claimed in claim 3, wherein the vehicle unit has a cover for covering the charging connector, wherein the cover, when in the closed state, lies flat with the floorpan.

5: The vehicle unit as claimed in claim 4, wherein the cover is movable, by means of a drive, between a closed position and an open position, and the drive is configured to also actuate the pin.

6: The vehicle unit as claimed in claim 5, wherein the vehicle unit comprises a housing defining a recess, wherein the recess is an elongated recess, and the charging connector is arranged at a first end of the recess such that the contacts of the charging connector are parallel to the floorpan.

7: The vehicle unit as claimed in claim 6, wherein the positioning element, for the purpose of at least one of: positioning and guiding the contacting element, is arranged at the second end of the recess, opposite the charging connector.

8: The vehicle unit as claimed in claim 7, wherein the positioning element is connected via a toggle lever arrangement to a drive for at least one of: opening and closing a cover of the recess.

9: The vehicle unit as claimed in claim 8, wherein the positioning element is movable in the direction of the charging connector in order to effect coupling of the contacting element to the charging connector.

10: The vehicle unit as claimed in claim 9, wherein a drive for the cover has an over-center kinematic system by which the cover, when in the closed state, can be closed in a tight manner.

11: The vehicle unit as claimed in claim 10, wherein the drive for the cover is coupled to a drive of the positioning element in such a manner that, when the cover is opened, the positioning element is rotated in the direction of the floor and, when the cover is closed, the positioning element is rotated back into the recess, wherein the positioning element is rotated through an angle that is greater than 30°.

12: A charging device for charging a battery of an electric vehicle, comprising a vehicle unit and a floor unit arranged on the floor and having a contacting element attached to a contacting arm-, wherein the contacting element is configured to connect to the charging connector of the vehicle unit for the purpose of establishing an electrical connection, wherein
the charging connector and the contacting element are designed to be connected to each other in a plane parallel to the floorpan of the vehicle.

13: The charging device as claimed in claim 12, wherein the contacting element is arranged on the contacting arm in such a manner that it is always aligned parallel to the floorpan, irrespective of the position of the contacting arm, by means of a parallelogram guide.

14: The charging device as claimed in claim 13, wherein the contacting element has a receiving unit for receiving the positioning element to enable positioning of the contacting element with respect to the vehicle unit.

15: The charging device as claimed in claim 14, wherein the receiving unit and the vehicle unit have sensors for locating the receiving unit with respect to the vehicle unit and with respect to the recess.

16: A method for automatically charging an electric vehicle, comprising:
providing a vehicle unit mounted in the floorpan of the electric vehicle and comprising a charging connector, wherein the charging connector is arranged parallel to the floorpan of the electric vehicle;
providing a floor unit having a contacting arm at the free end of which a contacting element is arranged in a plane parallel to the floorpan of the vehicle;
approaching the contacting arm to the vehicle unit; and
displacing the contacting element in the direction of the charging connector, parallel to the floorpan of the electric vehicle.

17: The method as claimed in claim 16, wherein after the contacting element has been approached to the vehicle unit, a receiving unit of the contacting element is brought into engagement with a positioning unit of the vehicle unit to form a pivot axis, and an alignment of the contacting element with respect to the vehicle unit is effected by a pivoting of the contacting element about the pivot axis, caused by a movement of the contacting arm.

18: The charging device as claimed in claim 12, wherein the vehicle unit comprises the charging connector for charging a battery of the electric vehicle, wherein the vehicle unit is arranged in the floorpan of the electric vehicle.
